(19) United States
(12) Patent Application Publication
(10) Pub. No.: US 2006/0116454 A1
(43) Pub. Date: Jun. 1, 2006

(54) Stable thermally coaguable polyurethane dispersions

(76) Inventors: Bedri Erdem, Pearland, TX (US); Debkumar Bhattacharjee, Lake Jackson, TX (US); Ramki Subramanian, Pearland, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 11/001,406

(22) Filed: Dec. 1, 2004

(51) Int. Cl. C07F 9/6574

(52) U.S. Cl. 524/119

(57) ABSTRACT

A stable thermally coaguable polyurethane, which can form moisture resistant polyurethane articles is comprised of water having therein an external surfactant, an electrolyte and polyurethane particles, wherein the polyurethane particles are comprised of a nonionizable polyurethane that has ethylene oxide units in an amount that is insufficient to render a stable aqueous polyurethane dispersion in the absence of the external surfactant. A portion of the ethylene oxide units are of a mono hydroxyl polyethylene oxide having a molecular weight of 400 to 1500, polyethylene oxide diol having a molecular weight of 800 to 3000 or combination thereof.

### FIELD OF THE INVENTION

The invention relates to improved heat coaguable polyurethane dispersions.

### BACKGROUND OF THE INVENTION

Polyurethanes are produced by the reaction of polyisocyanates and polyols or polyamines (compounds having an active hydrogen). Aqueous dispersions of polyurethane particles are known. For example, U.S. Pat. Nos. 2,968,575 and 3,294,724 describe aqueous polyurethane dispersions dispersed using a separately added surfactant. These polyurethane dispersions are commonly referred to as externally stabilized. Because of the external surfactant, which by its very aspect is soluble in water, coatings made from these dispersions have reduced properties such as decreased moisture resistance (See, U.S. Pat. Nos. 4,066,591 and 3,920,598).

To remedy the aforementioned problem with externally stabilized polyurethane dispersions, internally stabilized dispersions have been described. An internally stabilized polyurethane dispersion is one that is stabilized through the incorporation of ionically or nonionically hydrophilic pendant groups within the polyurethane of the particles dispersed in the liquid medium. Examples of nonionic internally stabilized polyurethane dispersions are described by U.S. Pat. Nos. 3,905,929 and 3,920,598, which contain pendant polyethylene oxide side chains.

Ionic internally stabilized polyurethane dispersions are well known and are described in col. 5, lines 4-68 and col. 6, lines 1 and 2 of U.S. Pat. No. 6,231,926 and U.S. Pat. Nos. 3,412,054; 3,479,310 and 4,066,591. Typically, dihydroxyalkylcarboxylic acids such as described by U.S. Pat. No. 3,412,054 are used to make anionic internally stabilized polyurethane dispersions. A common monomer used to make an anionic internally stabilized polyurethane dispersion is dimethylolpropionic acid (DMPA).

Thermally coaguable polyurethane dispersions have been described to impregnate textiles or fleeces, make fiber filaments, make thin layer articles (e.g., gloves) and make more efficiently dried coatings. For example, the nonionically stabilized dispersions are known to be heat sensitive at moderate temperatures, but articles made from these dispersions display low moisture resistance due to the large amount of hydrophilic polyethylene oxide chains needed to make a stable aqueous dispersion.

U.S. Pat. No. 4,293,474 describes a thermally coaguable aqueous polyurethane dispersion in which the polyurethane particles have both an internal ionic and nonionic surfactant component and the dispersion contains an electrolyte dissolved in the water. However, the coagulation point (temperature) can not be adjusted with accuracy and changes during storage as described in U.S. Pat. No. 4,888,379 referring to German Published Specification 2,659,617, which is equivalent to U.S. Pat. No. 4,293,474.

More recently, U.S. Pat. No. 4,888,379 described an aqueous thermally coaguable dispersion where the polyurethane particles have internal ionic surfactant and a water soluble polyether urethane along with an electrolyte dissolved in the water. Because of the high concentration of lower molecular weight water soluble species, a coating made from these dispersions will suffer from poor properties such as low moisture resistance.

Consequently, it would be desirable to provide a thermally coaguable polyurethane dispersion, that avoids the problems of the prior art, such as, storage stability, varying coagulant temperature upon storage and coatings having reduced moisture resistance.

### SUMMARY OF THE INVENTION

The invention is directed to polyurethane dispersions that display coagulation at substantially unvarying elevated temperatures even after being stored at room temperature for an extended time. In addition, the polyurethane dispersion may be used to make coatings, reduced density articles with cellular structure, or impreganation layers having improved moisture resistance compared to other thermally coaguable polyurethane dispersions.

A first aspect of the invention is a stable thermally coaguable polyurethane dispersion comprising: water having therein an external surfactant, an electrolyte and polyurethane particles, wherein the polyurethane particles are comprised of a nonionizable poly urea/urethane that has ethylene oxide units in an amount that is insufficient to render a stable aqueous polyurethane dispersion in the absence of the external surfactant wherein at least a portion of the ethylene oxide units are of a mono hydroxyl polyethylene oxide having a molecular weight of 400 to 1500, nonionic polyethylene oxide diol having a molecular weight of 800 to 3000 or combination thereof. Surprisingly, the thermally coaguable dispersion has substantially unvarying coagulation temperature upon storage, while still being stable for long periods of time.

A second aspect of the invention is a method of forming a moisture resistant polyurethane article comprising:

(i) heating a polyurethane dispersion to a coagulating temperature for a time sufficient to form a coagulated polyurethane article, the polyurethane dispersion being comprised of, water having therein an external surfactant, an electrolyte and polyurethane particles, wherein the polyurethane particles are comprised of a nonionizable polyurethane, and

(ii) heating the coagulated polyurethane article to a second temperature such that at least a portion of the external surfactant and at least a portion of the electrolyte form a water insoluble compound dispersed within the moisture resistant polyurethane article.

A third aspect of the invention is a polyurethane article comprised of coagulated polyurethane particles of the first aspect of this invention.

A fourth aspect of this invention is a polyurethane article made by the method of the second aspect of this invention.

The polyurethane dispersion is useful for applications that typically have utilized polyurethane. The polyurethane dispersion, method and polyurethane articles are particularly suitable for use as coatings, laminates, impregnating textiles, synthetic leather, flexible foams and the like for cushioning underlayments or backings for textile and non-textile flooring systems.

### DETAILED DESCRIPTION OF THE INVENTION

The invention is a shear and shelf stable thermally coaguable polyurethane dispersion. Stable means that the dispersion staying undisturbed after 2 weeks or more does not coagulate, substantially alter in particle size or viscosity while still coagulating at substantially the same coagulating temperature after being freshly made. The particle size is substantially altered, generally, when the mean particle diameter on a volume basis increases by more than about 100 percent. Similarly, a substantial alteration of viscosity is, generally, when the viscosity increases by more than about 50 percent under a given shear condition. A substantially same coagulating temperature is, generally, when the coagulation temperature is at least within 5° C. of the initial coagulation temperature after 2 weeks of storage.

Preferably, the polyurethane dispersion has a mean particle size that is no more than about 90 percent larger on a volume average basis after two weeks of storage compared to the freshly made mean particle size. The particle size may be determined, for example, by a dynamic light scattering technique. More preferably, the mean particle size is no more than about 80 percent, and most preferably at most about 50 percent larger than the freshly made mean particle size. Similarly, the viscosity is preferably at most about 40 percent, more preferably at most about 35 percent and most preferably at most about 30 percent larger than the freshly made viscosity. In a most preferred embodiment, the viscosity is within 10 percent of the initial viscosity after 2 weeks or more of storage.

The coagulation temperature after 2 weeks of storage or more is preferably within about 4° C., more preferably within 3° C., and most preferably within about 2° C. of the freshly made coagulation temperature. In a most preferred embodiment, the coagulation temperature, after two weeks or more of storage, is within about 1° C. of the freshly made polyurethane dispersion.

The polyurethane dispersion is comprised of polyurethane particles of nonionizable polyurethane. Nonionizable polyurethane is a polyurethane that does not contain a hydrophilic ionizable group. A hydrophilic ionizable group is one that is readily ionized in water such as dimethylolpropionic acid (DMPA). Examples of other ionizable groups include anionic groups such as carboxylic acids, sulfonic acids and alkali metal salts thereof. Examples of cationic groups include ammonium salts reaction of a tertiary amine and strong mineral acids such as phosphoric acid, sulfuric acid, hydrohalic acids or strong organic acids or by reaction with suitable quartinizing agents such as C₁-C₆ alkyl halides or benzyl halides (for example, Br or Cl).

The nonionizable polyurethane has ethylene oxide units in an amount that is insufficient to render a stable aqueous polyurethane dispersion in the absence of the external surfactant. An insufficient amount of ethylene oxide units means that a polyurethane dispersion having no external surfactant, would either not be able to be made in the first place, or would by unstable as defined previously (would coagulate or substantially alter its mean particle size or viscosity after being stored for 2 weeks at room temperature).

However, the nonionizable polyurethane must contain some ethylene oxide units, to make the stable thermally coaguable polyurethane dispersion of this invention. Generally, the amount of ethylene oxide units in the nonionizable polyurethane is at least about 0.1 percent to at most about 20 percent by weight of the nonionizable polyurethane. Preferably, the amount of ethylene oxide units is at least about 0.5 percent, more preferably at least about 0.75 percent, even more preferably at least about 1 percent and most preferably at least about 1.5 percent to preferably at most about 15 percent, more preferably at most about 10 percent, even more preferably at most about 9 percent, and most preferably at most about 8 percent by weight of the nonionizable polyurethane.

Ethylene oxide units herein means a group formed from ethylene oxide as shown by the following formula.
—CH₂—CH₂—O—

The ethylene oxide units within the polyurethane are at least partially derived from a mono hydroxyl polyethylene oxide having a molecular weight of 400 to 1500, polyethylene oxide diol having a molecular weight of 800 to 3000 or combinations thereof. Illustratively, it is preferred to have at least about 10 percent by weight of the ethylene oxide of the polyurethane to be of one or more of the aforementioned hydroxyl polyethylene oxides. More preferably at least about 25 percent, even more preferably at least about 35 percent, and most preferably at least about 50 percent by weight of the ethylene oxide in the polyurethane is of the aforementioned polyethylene oxides. Such polyethylene oxides are well known and are available from The Dow Chemical Company under the CARBOWAX tradename. *Trademark of The Dow Chemical Company.

The amount aforementioned polyethylene oxide compounds present in the polyurethane generally is less than about 6 percent by weight of the polyurethane, otherwise the dispersion may become too stable and difficult to thermally coagulate or become too hydrophilic deleteriously affecting, for example, film properties such as water resistance (swelling). Preferably, the amount of these compounds is at most about 5.5 percent, more preferably at most about 5 percent and most preferably at most about 4.5 percent by weight of the polyurethane particles of the dispersion.

The polyurethane dispersion contains an external surfactant. The external surfactant may be cationic, anionic, or nonionic. Suitable classes of surfactants include, but are not restricted to, sulfates of ethoxylated phenols such as poly(oxy-1,2-ethanediyl)α-sulfo-ω(nonylphenoxy) ammonium salt; alkali metal fatty acid salts such as alkali metal oleates and stearates; polyoxyalkylene nonionics such as polyethylene oxide, polypropylene oxide, polybutylene oxide, and copolymers thereof; alcohol alkoxylates; ethoxylated fatty acid esters and alkylphenol ethoxylates; alkali metal lauryl sulfates; amine lauryl sulfates such as triethanolamine lauryl sulfate; quaternary ammonium surfactants; alkali metal alkylbenzene sulfonates such as branched and linear sodium dodecylbenzene sulfonates; amine alkyl benzene sulfonates such as triethanolamine dodecylbenzene sulfonate; anionic and nonionic fluorocarbon surfactants such as fluorinated alkyl esters and alkali metal perfluoroalkyl sulfonates; organosilicon surfactants such as modified polydimethylsiloxanes; and alkali metal soaps of modified resins.

Preferably, the external surfactant is ionic. More preferably, the external surfactant is anionic. In a preferred embodiment, the surfactant is an ionic surfactant that can react with a multivalent cation, present in one or more of the electrolytes present in the polyurethane dispersion such that a water insoluble compound is formed, such as an insoluble multivalent cation water insoluble salt of an organic acid, for example, upon drying of the coagulated polyurethane dispersion. Exemplary preferred surfactants include disodium octadecyl sulfosuccinimate, sodium dodecylbenzene sulfonate, sodium stearate and ammonium stearate.

The polyurethane dispersion contains an electrolyte. The electrolyte may be a monovalent or multivalent neutral salt that is capable of being dissolved in water and causes the nonionizable aqueous polyurethane dispersion to thermally coagulate as described above. Preferably, the coagulant is a neutral salt that at least in part reacts with the external surfactant to form an water insoluble compound such as a water insoluble salt of an organic acid, for example at the coagulating temperature or second higher temperature.

Desirably, the insoluble salt results from the reaction of a multivalent cation of the electrolyte replacing, for example, a monovalent cation of the surfactant, thus producing a multivalent cation water insoluble salt of an organic acid. Examples of neutral salts include sodium chloride, silver chloride, silver bromide, silver chromate, barium fluoride, barium carbonate, magnesium carbonate, calcium carbonate, silver nitrate, copper sulfate, magnesium nitrate, calcium nitrate, strontium nitrate and barium nitrate. Preferably, the coagulant is an alkaline earth salt. More preferably, the coagulant is an alkaline earth nitrate. Most preferably, the coagulant is a calcium salt such as calcium nitrate.

The amount of external surfactant and electrolyte may be any suitable amount. Generally, the amount of external surfactant is about 0.1 percent to about 10 percent by weight of the total weight of the polyurethane dispersion. Preferably, the amount external surfactant is at least about 0.5 percent, more preferably at least about 1 percent and most preferably at least about 1.5 percent to preferably at most about 8 percent, more preferably at most about 7 percent, and most preferably at most about 6 percent, by weight of the total weight of the polyurethane dispersion.

The amount of electrolyte may be any suitable such that the polyurethane dispersion remains stable and is thermally coaguable as described above. Generally, the amount of electrolyte given by a molar ratio to the amount of surfactant is about 0.01 to 10 and the amount chosen is dependent on the application and coagulation temperature desired. Preferably the electrolyte to surfactant ratio is at least about 0.1, more preferably at least about 0.25, and most preferably at least about 0.5.

In a preferred embodiment, the stable thermally coaguable polyurethane dispersion is one in which the dispersion is substantially free of organic solvents. Substantially free of organic solvents means that the dispersion was made without any intentional addition of organic solvents to make the prepolymer or the dispersion. That is not to say that some amount of solvent may be present due to unintentional sources such as contamination from cleaning the reactor. Generally, the aqueous dispersion has at most about 1 percent by weight of the total weight of the dispersion. Preferably, the aqueous dispersion has at most about 2000 parts per million by weight (ppm), more preferably at most about 1000 ppm, even more preferably at most about 500 ppm and most preferably at most a trace amount of a solvent. In a preferred embodiment, no organic solvent is used, and the aqueous dispersion has no detectable organic solvent present (i.e., “essentially free” of an organic solvent).

The stable thermally coaguable polyurethane dispersion may be mixed with another polymer dispersion or emulsion so long as the majority of the dispersion is a polyurethane dispersion and the stability and coagulation is not adversely affected. Other polymer dispersions or emulsions that may be useful when mixed with the polyurethane dispersion include polymers such as polyacrylates, polyisoprene, polyolefins, polyvinyl alcohol, nitrile rubber, natural rubber and co-polymers of styrene and butadiene. Most preferably, the polyurethane dispersion is made up polymer particles that are only polyurethane particles of the nonionizable polyurethane.

The stable thermally coaguable polyurethane dispersion may have, depending on the application, other suitable components such as those known in the art. For example, the polyurethane dispersion may have additives such as Theological modifiers, defoamers, antioxidants, pigments, water insoluble fillers, dyes, crosslinkers and combinations thereof.

The stable thermally coaguable dispersion may have any suitable solids loading of polyurethane particles, which typically depends on the particular application. Generally, the solids loading of the polyurethane particles is between 1 percent to 70 percent solids by weight of the total dispersion weight. Preferably, the solids loading is at least 2 percent, more preferably at least 4 percent and most preferably at least 6 percent to preferably at most 65 percent, more preferably at most 60 percent and most preferably at most 55 percent by weight.

Generally, the stable thermally coaguable dispersion may have a viscosity that varies over a wide range depending on the solids loading of the polyurethane particles and any other additives that may be present. Desirably the polyurethane dispersion is easily pumped, while still being able to be cast and retain its shape to form a polyurethane article. Generally, the viscosity is from at least about 10 centipoise (cp) to at most about 40,000 cp as measured using a Brookfield Model RVDVE 115 viscometer employing a #6 spindle rotated at 20 revolutions per minute (rpm). Preferably, the viscosity is at least about 50 cp to at most about 30000 cp. More preferably, the viscosity is at least about 100 cp to at most about 25000 cp. The dispersion desirably may display non-Newtonian pseudoplastic behavior when used for certain applications such as carpet backing. This rheology, for example, resists filler fall-out, aids in coating placement and coating weight control.

The mean particle size by volume of the polyurethane particles generally is at most about 10 micrometers in diameter to at least about 0.01 micrometers. Preferably, the mean particle size is at most about 5 micrometers, more preferably at most about 2 micrometers and most preferably at most about 1 micrometer to preferably at least about 0.03, more preferably at least about 0.05 micrometer and most preferably at least about 0.1 micrometer.

Generally, the coagulation temperature of the stable thermally coaguable polyurethane dispersion is at least about 5° C. above room temperature, but below the boiling temperature of water. Preferably, the coagulation temperature of the dispersion is at least about 30° C., more preferably at least about 35° C., and most preferably at least about 40° C. to preferably at most about 80° C., more preferably at most about 65° C., and most preferably at most about 60° C.

Generally, the nonionizable polyurethane is prepared by reacting a polyurethane/urea/thiourea prepolymer with a chain-extending reagent in an aqueous medium and in the presence of a stabilizing amount of an external surfactant so long as at least one of the reactants contain the previously described ethylene oxide units. The polyurethane/urea/thiourea prepolymer can be prepared by any suitable method such as those well known in the art. The prepolymer is advantageously prepared by contacting a high molecular weight organic compound having at least two active hydrogen atoms with sufficient polyisocyanate, and under such conditions to ensure that the prepolymer is isocyanate terminated as described in U.S. Pat. No. 5,959,027, incorporated herein by reference.

The polyisocyanate is preferably an organic diisocyanate, and may be aromatic, aliphatic, or cycloaliphatic, or a combination thereof. Representative examples of diisocyanates suitable for the preparation of the prepolymer include those disclosed in U.S. Pat. No. 3,294,724, column 1, lines 55 to 72, and column 2, lines 1 to 9, incorporated herein by reference, as well as U.S. Pat. No. 3,410,817, column 2, lines 62 to 72, and column 3, lines 1 to 24, also incorporated herein by reference. Preferred diisocyanates include 4,4′-diisocyanatodiphenylmethane, 2,4′-diisocyanatodiphenylmethane, isophorone diisocyanate, p-phenylene diisocyanate, 2,6 toluene diisocyanate, polyphenyl polymethylene polyisocyanate, 1,3-bis(isocyanatomethyl)cyclohexane, 1,4-diisocyanatocyclohexane, hexamethylene diisocyanate, 1,5-naphthalene diisocyanate, 3,3′-dimethyl-4,4′-biphenyl diisocyanate, 4,4′-diisocyanatodicyclohexylmethane, 2,4′-diisocyanatodicyclohexylmethane, and 2,4-toluene diisocyanate, or combinations thereof. More preferred diisocyanates are 4,4′-diisocyanatodicyclohexylmethane, 4,4′-diisocyanatodiphenylmethane, 2,4′-diisocyanatodicyclohexylmethane, and 2,4′-diisocyanatodiphenylmethane. Most preferred is 4,4′-diisocyanatodiphenylmethane and 2,4′-diisocyanatodiphenylmethane.

As used herein, the term “active hydrogen group” refers to a group that reacts with an isocyanate group to form a urea group, a thiourea group, or a urethane group as illustrated by the general reaction:

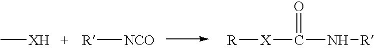

where X is O, S, NH, or N, and R and R′ are connecting groups which may be aliphatic, aromatic, or cycloaliphatic, or combinations thereof. The high molecular weight organic compound with at least two active hydrogen atoms typically has a molecular weight of not less than 500 Daltons.

The high molecular weight organic compound having at least two active hydrogen atoms may be a polyol, a polyamine, a polythiol, or a compound containing combinations of amines, thiols, and ethers. Depending on the properties desired, the polyol, polyamine, or polythiol compound may be primarily a diol, triol or polyol having greater active hydrogen functionality or a mixture thereof. It is also understood that these mixtures may have an overall active hydrogen functionality that is slightly below 2, for example, due to a small amount of monol in a polyol mixture.

Preferably, the high molecular weight organic compound having at least two active hydrogen atoms is a polyalkylene glycol ether or thioether or polyester polyol or polythiol having the general formula:

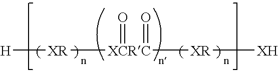

where each R is independently an alkylene radical; R′ is an alkylene or an arylene radical; each X is independently S or O, preferably O; n is a positive integer; and n′ is a non-negative integer.

Generally, the high molecular weight organic compound having at least two active hydrogen atoms has a weight average molecular weight of at least about 500 Daltons, preferably at least about 750 Daltons, and more preferably at least about 1000 Daltons. Preferably, the weight average molecular weight is at most about 20,000 Daltons, more preferably at most about 10,000 Daltons, more preferably at most about 5000 Daltons, and most preferably at most about 3000 Daltons.

Polyalkylene ether glycols and polyester polyols are preferred. Representative examples of polyalkylene ether glycols are polyethylene ether glycols, poly-1,2-propylene ether glycols, polytetramethylene ether glycols, poly-1,2-dimethylethylene ether glycols, poly-1,2-butylene ether glycol, and polydecamethylene ether glycols. Preferred polyester polyols include polybutylene adipate, caprolactone based polyester polyol and polyethylene terephthalate.

The NCO:XH ratio may be any suitable to form a polyurethane dispersion including ratios that result, for example, in OH terminated prepolymers. Preferably the NCO:XH ratio is not less than 1.1:1, more preferably not less than 1.2:1, and preferably not greater than 5:1.

The polyurethane prepolymer may be prepared by a batch or a continuous process. Useful methods include methods such as those known in the art. For example, a stoichiometric excess of a diisocyanate and a polyol can be introduced in separate streams into a static or an active mixer at a temperature suitable for controlled reaction of the reagents, typically from about 40° C. to about 100° C. A catalyst may be used to facilitate the reaction of the reagents such as an organotin catalyst (e.g., stannous octoate). The reaction is generally carried to substantial completion in a mixing tank to form the prepolymer.

The external stabilizing surfactant may be cationic, anionic, or nonionic. Suitable classes of surfactants include, but are not restricted to, sulfates of ethoxylated phenols such as poly(oxy-1,2-ethanediyl)α-sulfo-ω(nonylphenoxy) ammonium salt; alkali metal fatty acid salts such as alkali metal oleates and stearates; polyoxyalkylene nonionics such as polyethylene oxide, polypropylene oxide, polybutylene oxide, and copolymers thereof; alcohol alkoxylates; ethoxylated fatty acid esters and alkylphenol ethoxylates; alkali metal lauryl sulfates; amine lauryl sulfates such as triethanolamine lauryl sulfate; quaternary ammonium surfactants; alkali metal alkylbenzene sulfonates such as branched and linear sodium dodecylbenzene sulfonates; amine alkyl benzene sulfonates such as triethanolamine dodecylbenzene sulfonate; anionic and nonionic fluorocarbon surfactants such as fluorinated alkyl esters and alkali metal perfluoroalkyl sulfonates; organosilicon surfactants such as modified polydimethylsiloxanes; and alkali metal soaps of modified resins.

The polyurethane dispersion may be prepared by any suitable method such as those well known in the art. (See, for example, U.S. Pat. No. 5,539,021, column 1, lines 9 to 45, which teachings are incorporated herein by reference.)

When making the polyurethane dispersion, the prepolymer may be extended by water solely, or may be extended using a chain extender such as those known in the art. When used, the chain extender may be any isocyanate reactive diamine or amine having another isocyanate reactive group and a molecular weight of from about 60 to about 450, but is preferably selected from the group consisting of: an aminated polyether diol; piperazine, aminoethylethanolamine, ethanolamine, ethylenediamine and hydrazine, diethyl triemaine mixtures thereof. Preferably, the amine chain extender is dissolved in the water used to make the dispersion.

In making the polyurethane dispersion, the electrolyte may be added at any suitable time during the process. Preferably, the electrolyte is added after the polyurethane dispersion is formed. The electrolyte may first be dissolved in water and subsequently added to the dispersion or added directly while agitating the polyurethane dispersion.

Once the dispersion is formed, a polyurethane object may be made therefrom. The polyurethane object may be made by any known method to form objects from a polyurethane dispersion. For example, the dispersion may be coated upon a substrate and the temperature raised such that the dispersion coagulates which then may be further dried at a second temperature. In addition, other shapes and forms may be made in a like manner such as drawing a fiber.

In a preferred embodiment, the dispersion is coagulated at a coagulating temperature to form a shape, coating or the like and then is subsequently raised to a higher second temperature. The higher second temperature aids in drying and may aid in the formation of a water insoluble compound from the external surfactant and electroyte.

In this preferred embodiment, the resultant polyurethane article is comprised of polyurethane and a water insoluble compound. Illustratively and preferably, the water insoluble compound is a multivalent cation substantially water insoluble salt of an organic acid (for example, sulfonates, sulfates, and carboxylates), which arise, for example, from the reaction of a multivalent metal cation in the electroyte with the organic acid of a water soluble monovalent cation organic acid surfactant described previously.

Examples of multivalent cation water insoluble salts include multivalent cation salts of organic acids selected from the group consisting of butyric acid, hexanoic acid, octanoic acid, decanoic acid, dodecanoic acid, lauric acid, myristic acid, palmitic acid, oleic acid, linoleic acid, stearic acid, linolenic acid, gum rosin, wood rosin, tall oil rosin, abietic acid, oxidized polyethylene containing carboxylic acid groups, ethylene-acrylic acid copolymers, ethylene-methacrylic acid copolymers, polyolefins grafted with unsaturated carboxylic acids, polyolefins grafted with anhydrides, methacrylic acid, maleic acid, fumaric acid, acrylic acid, and alkylbenzene sulfonic acid.

Other examples include multivalent cations reacted with alkali metal lauryl sulfates; amine lauryl sulfates such as triethanolamine lauryl sulfate; quaternary ammonium surfactants; alkali metal alkylbenzene sulfonates such as branched and linear sodium dodecylbenzene sulfonates; amine alkyl benzene sulfonates such as triethanolamine dodecylbenzene sulfonate; anionic and nonionic fluorocarbon surfactants such as fluorinated alkyl esters and alkali metal perfluoroalkyl sulfonates; organosilicon surfactants such as modified polydimethylsiloxanes; and alkali metal soaps of modified resins. Preferably, the multivalent cation water insoluble salt is one where the cation is an alkaline earth that has reacted with disodium octadecyl sulfosuccinimate, sodium dodecyl benzene sulfonate, sodium stearate and ammonium stearate.

The multivalent cation is preferably an alkaline earth cation. More preferably, the multivalent cation is Ca, Mg or Sr or Al. Most preferably, the multivalent cation is Ca.

The amount of multivalent cation remaining in the polyurethane article may vary over a wide range, but typically is from 10 ppm to 20,000 ppm by weight of the polyurethane. The amount employed may vary, for example, due to the moles equivalent of the surfactant used and temperature desired to coagulate the dispersion. Preferably, the amount of the multivalent cation in the polyurethane is at least 20, more preferably at least 50 and most preferably at least 100 ppm to preferably at most 10,000 ppm, more preferably at most 5000 ppm and most preferably at most 2500 ppm by weight of the polyurethane. The amount of the multivalent cation may be determined by known methods such as neutron activation analysis.

Surprisingly, the polyurethane article (e.g., coating, synthetic leather or carpet backing) has good moisture resistance, even though the dispersion has an external surfactant. This is believed to be due to the ability to form water insoluble compounds from the external surfactant in the polyurethane article, the low concentration of ethylene oxide units present in the polyurethane itself and the lack of hydrophilic ionic groups within the polyurethane. These properties may be improved further, for example, by crosslinking the polyurethane by any suitable method such as those known in the art such as crosslinking techniques employing aminosilanes, epoxy silanes, aziridide or carbodiimide cross-linkers.

The coagulating temperature may be any temperature as previously described. The second temperature used to dry the coagulated dispersion, may be any suitable temperature depending on the application. Preferably, the second temperature is higher than the coagulating temperature. Preferably, the second temperature is at least 10° C. greater than the coagulating temperature. More preferably, the drying temperature is greater than the boiling point of water, but not so high that it degrades the polyurethane.

### EXAMPLES

Each of the following Examples and Comparative Examples uses the following prepolymer unless stated otherwise. About 447 parts by weight (pbw) of VORANOL* 222-056 (a 2000 molecular weight “MW” polyoxypropylene diol having a total of 12.5 percent ethylene oxide by weight end capping available from The Dow Chemical Company, Midland, Mich.), about 16 pbw of CARBOWAX* 1000 (a polyethylene oxide glycol having a MW range of about 950 to 1050 available from The Dow Chemical Company), and about 16 pbw of a methoxypolyethylene glycol, a polyether monol having a molecular weight of about 950, are placed in a flask which is placed in an oven held at 70° C. for 30 minutes. To this mixture, about 289 pbw of ISONATE* 125M (diphenylmethane diisocyante having about 97 percent 4,4′-diphenylmethane diisocyanate and about 3 percent 2,4′-diphenylmethane diisocyanate, available from The Dow Chemical Company) is added. The mixture is vigorously stirred for 30 minutes and then placed in the oven at 70° C. for about 12 hours. The NCO content of the resultant prepolymer is about 6.9 percent by weight. (*Trademark of The Dow Chemical Company).

### Examples: 1-3

A polyurethane dispersion is made using the above prepolymer using the same procedure as the Example described in U.S. Pat. No. 6,087,440 except that (1) aminoethylethanolamine (AEEA) was used in place of the piperazine chain extender and the amount of the AEEA used is an amount equivalent to 30 percent of the NCO content of the prepolymer and (2) 3 parts by weight of sodium dodecyl benzene sulfonate surfactant per hundred parts by weight of polyurethane was used instead of the triethanolamine dodecylbenzene sulfonate. While stirring the dispersion, an amount of calcium nitrate was added in amount of moles calcium nitrate/mole of surfactant as shown in Table 1.

The average particle size by volume and number using dynamic light scattering and coagulation temperature were determined the same day each dispersion was made and after 18 days. These results are shown in Table 1 and by convention the “a” Example shows the results of the freshly made dispersion and the “b” Example shows the results after aging the same dispersion for 18 days. The coagulation temperature was determined by slowly heating the dispersion to 80° C. while measuring the viscosity of the dispersion. The coagulation temperature was given by a rapid rise in viscosity.

### Comparative Example 1

A dispersion was made in the same way as described for Examples 1-3 except that no calcium nitrate was added to the dispersion. The average particle size by volume and number using dynamic light scattering and coagulation temperature were determined the same day each dispersion was made and after 18 days. For this dispersion no coagulation temperature was found even after heating the dispersion to 80° C.

### Comparative 2

A polyurethane prepolymer was prepared by blending 52.3 wt percent VORANOL* 222-056, 14.7 wt percent polypropylene glycol P425 (425 MW polypropylene oxide based diol, available from The Dow Chemical Company) and 33 wt percent ISONATE* 125M (MDI). A drop of benzoyl chloride was added prior to heating the mixture to 80° C. The mixture was mixed at low rpm for 4 hours at 80° C. The resulting prepolymer had 5.9 wt percent NCO and a viscosity of 34,000 cps. (*Trademark of The Dow Chemical Company).

This prepolymer was then dispersed in the same way as Examples 1-3. The polyurethane dispersion had a solids content of about 50 wt percent. Upon addition of calcium nitrate, the dispersion coagulated.

TABLE 1
Dispersion Coagulation and Stability

| | | | Average | Average | |
|---|---|---|---|---|---|
| | | | particle | particle | |
| | | | size by | size by | Coagula- |
| | Days | Ca(NO₃)₂/ | number | volume | tion |
| | dispersion | Surfactant | (micro- | (micro- | Tempera- |
| Example | aged | by moles | meters) | meters) | ture (° C.) |
| 1a | 0 | 0.75 | 208 | 566 | 51.9 |
| 1b | 18 | 0.75 | 198 | 547 | 51.7 |
| 2a | 0 | 1.5 | 268 | 412 | 48.5 |
| 2b | 18 | 1.5 | 216 | 639 | 48.8 |
| 3a | 0 | 3 | 193 | 433 | 46.3 |
| 3b | 18 | 3 | 276 | 416 | 46.7 |
| Comp. | 0 | 0 | 190 | 648 | N/A |
| 1a | | | | | |
| Comp. | 18 | 0 | 190 | 648 | N/A |
| 1b | | | | | |

N/A = did not coagulate.

What is claimed is:

1. A stable thermally coaguable polyurethane dispersion comprising: water having therein an external surfactant, an electrolyte and polyurethane particles, wherein the polyurethane particles are comprised of a nonionizable polyurethane that has ethylene oxide units in an amount that is insufficient to render a stable aqueous polyurethane dispersion in the absence of the external surfactant wherein at least a portion of the ethylene oxide units are of a mono hydroxyl polyethylene oxide having a molecular weight of 400 to 1500, polyethylene oxide diol having a molecular weight of 800 to 3000 or combination thereof.

2. The polyurethane dispersion of claim 1 wherein the amount of amount ethylene oxide units within the nonionizable polyurethane is at least about 0.1 percent to at most about 20 percent by weight of the nonionizable polyurethane.

3. The polyurethane dispersion of claim 2, wherein the amount of ethylene oxide units is at least about 0.5 percent.

4. The polyurethane dispersion of claim 3, wherein the amount of ethylene oxide units is at least about 1 percent.

5. The polyurethane dispersion of claim 2, wherein the amount of ethylene oxide units is at most about 15 percent.

6. The polyurethane dispersion of claim 5, wherein the amount of ethylene oxide units is at most about 10 percent.

7. The polyurethane dispersion of claim 1, wherein the polyurethane dispersion is substantially free of an organic solvent.

8. The polyurethane dispersion of claim 7, wherein the polyurethane dispersion has at most 2000 ppm by weight of the organic solvent.

9. The polyurethane dispersion of claim 1, wherein the electrolyte is a multivalent cation neutral salt.

10. The polyurethane dispersion of claim 9, wherein the electrolyte is an alkaline earth cation salt.

11. The polyurethane dispersion of claim 10, wherein the alkaline earth cation salt is calcium nitrate, magnesium nitrate, strontium nitrate and barium nitrate or mixture thereof.

12. The polyurethane dispersion of claim 1, wherein the polyurethane has a ratio by moles of electrolyte to surfactant of about 0.01 to about 10.

13. The polyurethane dispersion of claim 12, wherein the ratio is at least about 0.25.

14. The polyurethane dispersion of claim 13, wherein the ratio is at least about 0.5.

15. The polyurethane dispersion of claim 9, wherein the external surfactant is an ionic surfactant.

16. The polyurethane dispersion of claim 15, wherein the ionic surfactant is an anionic surfactant.

17. The polyurethane dispersion of claim 16, wherein the anionic surfactant has a monovalent metal cation.

18. The polyurethane dispersion of claim 17, wherein the monovalent metal cation is Na, K, Li or combination thereof.

19. The polyurethane dispersion of claim 1, wherein the portion of the ethylene oxide units being of the mono hydroxyl polyethylene oxide having a molecular weight of 400 to 1500, nonionic polyethylene oxide diol having a molecular weight of 800 to 3000 or combination thereof is at least 10 percent by weight of the total amount of the ethylene oxide units present in the polyurethane particles.

20. The polyurethane dispersion of claim 19, wherein the portion is at least about 25 percent.

21. A method of forming a moisture resistant polyurethane article comprising:
(i) heating a polyurethane dispersion to a coagulating temperature for a time sufficient to form a coagulated polyurethane article, the polyurethane dispersion being comprised of, water having therein an external surfactant, an electrolyte and polyurethane particles, wherein the polyurethane particles are comprised of a nonionizable polyurethane, and
(ii) heating the coagulated polyurethane article to a second drying temperature such that at least a portion of the external surfactant and at least a portion of the electrolyte form a water insoluble compound dispersed within the moisture resistant polyurethane article.

22. The method of claim 21, wherein the electrolyte is a multivalent cation neutral salt.

23. The method of claim 22, wherein the electrolyte is an alkaline earth cation salt.

24. The method of claim 23, wherein the alkaline earth cation salt is calcium nitrate, magnesium nitrate, strontium nitrate and barium nitrate or mixture thereof.

25. The method of claim 22, wherein external surfactant is an ionic surfactant.

26. The method claim 25, wherein external surfactant is an anionic surfactant.

27. The method of claim 26, wherein the anionic surfactant has a monovalent metal cation.

28. The method of claim 27, wherein the nonionizable polyurethane has ethylene oxide units in an amount that is insufficient to render a stable aqueous polyurethane dispersion in the absence of the external surfactant wherein at least a portion of the ethylene oxide units are of a mono hydroxyl polyethylene oxide having a molecular weight of 400 to 1500, nonionic polyethylene oxide diol having a molecular weight of 800 to 3000 or combination thereof.

29. The method of claim 28, wherein the portion of the ethylene oxide units being of the mono hydroxyl polyethylene oxide having a molecular weight of 400 to 1500, nonionic polyethylene oxide diol having a molecular weight of 800 to 3000 or combination thereof is at least 10 percent by weight of the total amount of the ethylene oxide units present in the nonionizable polyurethane.

30. The method of claim 29, wherein the portion is at least about 25 percent.

31. The method of claim 21, wherein the second drying temperature is greater than the coagulating temperature.

32. The method of claim 31, wherein the second drying temperature is at least 10° C. greater than the coagulating temperature.

32. A polyurethane article comprised of fused polyurethane particles of the polyurethane dispersion of claim 1.

33. A polyurethane article formed by the method of claim 21.
